(19) United States
(12) Patent Application Publication
(10) Pub. No.: US 2010/0179846 A1
(43) Pub. Date: Jul. 15, 2010

(54) COMPUTERIZED PERSONAL SHOPPING ASSISTANT ORDERING IN A STORE

(75) Inventors: Steven F. Best, Action, MA (US); Robert J. Eggers, JR., Austin, TX (US); Janice M. Girouard, Austin, TX (US); Ramon A. Reveron, (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 12/352,677

(22) Filed: Jan. 13, 2009

(51) Int. Cl. G06Q 30/00; G06Q 10/00

(52) U.S. Cl. 705/8; 705/26

(57) ABSTRACT

One embodiment for ordering one or more items, i.e., goods or services, within a store includes choosing, by a person in a store, the one or more items on a computerized personal shopping assistant, wherein the computerized personal shopping assistant may be optionally associated with a cart. Further, the method includes selecting, by the person in the store, a request date-time on the computerized personal shopping assistant for each of the one or more items chosen, and, thereby, resulting in an order of one or more selected items at a selection date-time, wherein the request date-time is subsequent to the selection date-time. Further still, transmitting, by the computerized personal shopping assistant, the order to a data collection center associated with the store. Yet further, the method includes filling, by the store, the order after the transmitting and then providing the order by the request date-time subsequent to purchasing the order.

### BACKGROUND OF THE INVENTION

Today, retail stores are highly competitive in offering items, i.e., goods and services, for purchase, whether by sale or lease. Customers are becoming more interested in personalized marketing of items as well as access to information that is targeted to their unique needs and habits. Grocery stores, for instance, are an example of where customers can make in-store decisions about ordering and purchasing items through personalized marketing.

### BRIEF SUMMARY OF THE INVENTION

Embodiments of this disclosure generally provide methods, systems, and media for ordering one or more items in a store. One embodiment of the method includes choosing, by a person in a store, the one or more items on a computerized personal shopping assistant. Further, the method includes selecting, by the person in the store, a request date-time on the computerized personal shopping assistant for each of the one or more items chosen, and, thereby, resulting in an order of one or more selected items at a selection date-time, wherein the request date-time is subsequent to the selection date-time. Further still, transmitting, by the computerized personal shopping assistant, the order to a data collection center associated with the store. Yet further, the method includes filling, by the store, the order after the transmitting. Finally, the method includes providing, by the store, the order by the request date-time subsequent to purchasing the order.

In another embodiment, this disclosure provides a system for ordering of one or more items in a store. The system includes an application associated with a computerized personal shopping assistant having a processor, wherein the computerized personal shopping assistant is optionally associated with a cart. Further, the system includes an item selection module within the application available through the computerized personal shopping assistant, for choosing, by a person in a store, on the computerized personal shopping assistant, the one or more items. Further still, the system includes a request-date time module within the application available through the computerized personal shopping assistant, for selecting, by the person in the store, a request date-time on the computerized personal shopping assistant for each of the one or more items chosen, and, thereby, resulting in an order of one or more selected items at a selection date-time, wherein the request date-time is subsequent to the selection date-time. Yet further, the system includes a transmission module within the application available through the computerized personal shopping assistant, for transmitting, by the computerized personal shopping assistant, the order to a data collection center associated with the store. Finally, the system includes filling, by the store, the order after execution of the transmission module and receipt of the order by a receiver module, and then providing, by the store, the order by the request date-time subsequent to a purchase of the order.

In yet another embodiment, this disclosure provides a machine-accessible storage medium containing instructions for ordering one or more items in a store. The instructions generally include operations for choosing, by a person in a store, the one or more items on a computerized personal shopping assistant. Further, the instructions include operations for selecting, by the person in the store, a request date-time on the computerized personal shopping assistant for each of the one or more items chosen, and, thereby, resulting in an order of one or more selected items at a selection date-time, wherein the request date-time is subsequent to the selection date-time. Further still, the instructions include operations for transmitting, by the computerized personal shopping assistant, the order to a data collection center associated with the store. Yet further, the instructions include operations for filling, by the store, the order after performing the instructions for the transmitting. Finally, the instructions include operations for providing, by the store, the order by the request date-time subsequent to purchasing the order.

### BRIEF DESCRIPTION OF THE SEVERAL VIEWS OF THE DRAWING

So that the manner in which the above recited features, advantages and objects of the present disclosure are attained and can be understood in detail, a more particular description of this disclosure, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for this disclosure may admit to other equally effective embodiments.

FIG. 1 depicts an example embodiment of a system for ordering one on or more items in a store in accordance with this disclosure.

FIG. 2 depicts an example embodiment of a computerized personal shopping assistant (PSA) having an application enabling a screen to show menus on the PSA and accept a person's choosing and selecting of one or more items for ordering and optionally purchased on the PSA in a store in accordance with this disclosure.

FIG. 3 depicts an example embodiment of a method for ordering one on or more items in a store in accordance with this disclosure.

FIG. 4 depicts a computer system capable of use in a computerized personal shopping assistant (PSA) and in communication with a non-depicted data collection center associated with a store in accordance with this disclosure.

### DETAILED DESCRIPTION OF THE INVENTION

The following is a detailed description of example embodiments of this disclosure depicted in the accompanying drawings. The embodiments are examples and are in such detail as to clearly communicate this disclosure. However, the amount of detail offered is not intended to limit the anticipated variations of embodiments; on the contrary, the intention is to cover all modifications, equivalents, and alternatives falling within the spirit and scope of the present disclosure as may be defined by the appended claims. The detailed descriptions below are designed to make such embodiments obvious to a person of ordinary skill in the art.

Generally speaking, methods, systems and media for ordering one or more items in a store are contemplated. A device denominated a “computerized personal shopping assistant” (“PSA”) is available to a person coming into a store to shop for one or more items, i.e., goods or services for purchasing by sale or lease. The PSA, itself, may be integrally attached or removably attachable to a shopping cart, or, instead, may be a handheld; all of such embodiments may be used in the store for ordering by a person. An application associated with the PSA allows, through, for example, menus on the PSA's screen or a scanner stylus communicating with the application, to choose the quantity of an item and to select a request date-time for each item, wherein this choosing and selecting can be optionally repeated. The selecting of the request date-time may or may not be the same for each item for it depends on what the person desires and the availability of the selected items selected by the person in the store on the PSA enabled by the application. The entirety of the chosen and selected items comprise an order of items having at least one request date-time, which, naturally, occurs subsequent to the selection date-time. Prior to transmitting the order from the PSA to a data collection center associated with the store, the person may optionally purchase the order through another interface enabled by the application on the PSA. Further, the person may elect on the PSA via menu choices to ensure no receipt costs are shown on any receipt provided by the store when the store provides the order by the request date. Further still, the person may elect on the PSA via menu choices to have a receipt, with or without prices shown, electronically sent to the person associated with having selected the order. Subsequent to the application allowing the store to receive possession of the order by the transmitting, the store's employees, for instance, may fill the order by the request-date specified by the above-identified “person”, i.e., the shopper. Before providing the order on or subsequent to the request date-time to the shopper, or, to another person associated with the shopper, the application may allow the store to ensure payment was received at the time of the order; if not, then the person picking-up the order, or, the person to whom the store delivered the order, may pay for the order and optionally receive the receipt permitted by the application based on the shopper's prior, optional choices on the PSA. Prior to providing the order to the shopper, for example, the order may be optionally modified through the application associated with the PSA by a person, whether the shopper or another person associated with the shopper, changing the order in the store. Finally, the shopper or a different person associated with that shopper may alert the store of their presence in the store through the application associated with PSA. This informs the store that someone is in the store and ready to pick-up the order having a request-date, and, for the store to fetch the filled order or fill the order within a certain, limited time-frame.

The PSA, such as IBM's Retail Store Solution™ (RSS), offers customers in stores a device from which to place orders for items, which is the case in this disclosure. The RSS type of PSA is a shopping cart buddy in a detachable system, which is stored on recharging racks at the store entrance where a use can grab one and mount them to their cart if they choose. Instead, the customer in the store may carry the RSS type of PSA. The application associated with the PSA in this disclosure provides an ability to order items, such as groceries, in a store in advance. For example, a customer shopping for groceries in a Whole Foods store on a Tuesday night using a PSA may see a sampling of ready-made food or fresh fruit, i.e., perishable items, that the customer would like to consume over the weekend. Rather than the customer having to drop by again during that weekend and hope the product is still for purchase, the application associated with the PSA and a store's data collection center, at a minimum, allows the customer to order on Tuesday for the weekend.

When a shopper, also referred to simply as “a person in the store” herein, scans an item in a store with, for instance, a stylus tethered or wirelessly connected to the PSA, the PSA may ask for the request date-time and quantity desired, and then an order is placed. For clarity, in the previous paragraph's example, Friday at a selected specific time would have been the “request-date time”, and Tuesday was the “selection date-time” because the shopper placed the order on Tuesday in the store at the time the order was placed.

As another example, the shopper could use the PSA's and the associated application to place an order for an item now, but not take that current item. A typical example would be at the deli counter, where a shopper may wish to ask for another thickness or another quantity of food. Such would allow the shopper to make the request for the product at the cart, avoid waiting for the deli clerk, and have the product waiting at check-out, with, of course, appropriate notification through the PSA.

As yet another example, one choice provided to the shopper for “request date-time” may be “upon arrival”. Again, using the foregoing example regarding Friday, the shopper, e.g., a husband, or another person associated with the shopper, e.g., a wife, may arrive at the store on Friday and scan a grocery card, which alerts the grocery store in this instance that the customer, whether husband or wife in this example, is here and wants the order now or within a reasonable, limited amount of time, e.g., 15-30 minutes. This option associated with the PSA, application, and data collection center provides the option of exceptionally fresh products, while providing the grocery store with a customer encouraged to browse and make impulsive purchases while the order is fetched for providing to the customer. Furthermore, the store is better able to anticipate what items it will need on certain dates, and thereby, make safer outlays of money for future items as well as provide fresher products to its customers.

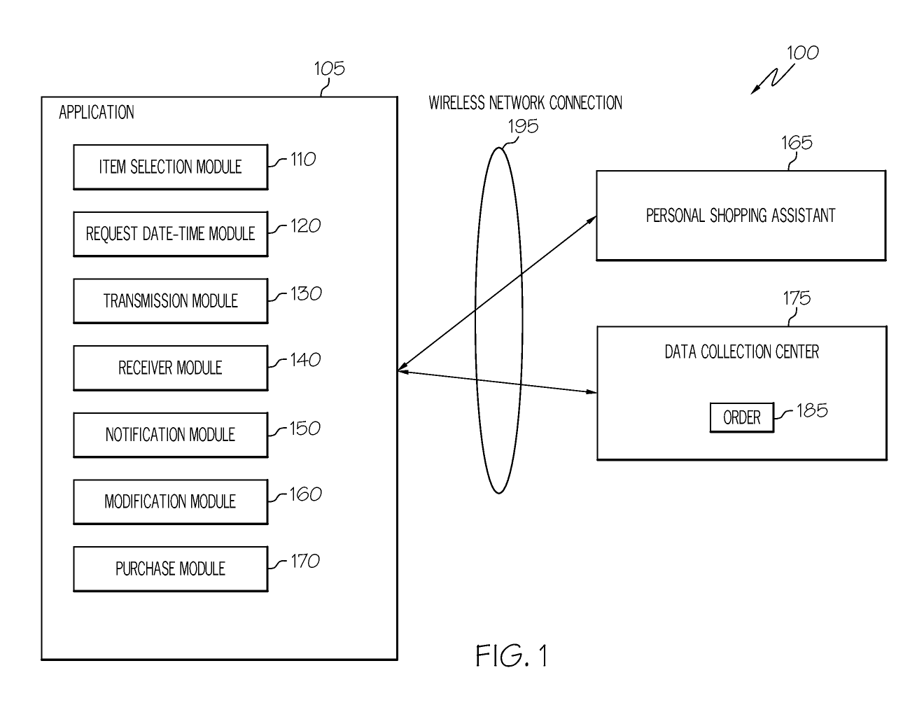

Turning now to the drawings, FIG. 1 depicts an example embodiment of a system 100 for ordering one or more items through an application 105 associated with both a computerized personal shopping assistant (PSA) 165 and a data collection center 175 in the store via one or more wireless network connections, such as wireless network connection 195, which, for example, may occur through Bluetooth™, IRDA, LAN or WAN. The application 105, itself, may actually be one or more applications as well as a multi-tiered application, such as a client-server application or browser-webserver application. Through enabling logic reduced to hardware and/or software, the application's 105 modules 110, 120, 130, 140, 150, 160, and 170, wherever such modules may reside within the system 100, are within the application 105 and allow the functionality underlying the ability for purchasing one or more ordered items by a person in a store using an interface on a PSA 165 in wireless network communication 195 with a store's data collection center 175, such as a non-depicted computer system having one or more logical and physical peripherals such as a mouse, printer, keyboard, screen, and storage, such as a database, RAM or ROM.

Discussing FIG. 1 in more detail, the application 105 in the example embodiment includes an item selection module 110. The item selection module 110, enabled by logic reduced to hardware and/or software, permits a person in a store to choose one or more items on a PSA 165. The item selection module 110 may permit choosing of each of the one or more items, including quantity of any particular item, that will ultimately comprise the person's order 185 may be accomplished by using a scanner pen tethered to or wirelessly in communication with the PSA 165. In this example embodiment, the person uses the PSA's 165 scanner pen to scan a uniform product code (UPC) associated with the particular item, an action the item selection module 110 interprets as a person choosing a particular item. In an alternative example embodiment, the person may scan the product, itself, or an image, e.g., facsimile, of the product, whether the product is or is not in the store. The item section module 110 may have further enabling logic that provides an interface for a person to have visual confirmation of the scanned, chosen item by the PSA's 165 scanner pen. As an alternative example, item selection module 110 may permit a person to choose each of the one or more items though use of an interface presented to the person on the PSA, and the person may uses a PSA 165 stylus or their finger on drop-down menus, radio button, check boxes, and so forth provided to show particular items, including quantity of any particular item and regardless whether the item is a goods or service, available for purchase in the store. The chosen items, themselves, may be items available or not currently available in the store but the latter will be available by the particular “request date-time” as discussed in the following paragraph. Furthermore, the chosen items may comprise perishable or non-perishable goods, such a baked dinner or canned corned, respectively, or, a service offered by the store, such as maid-service in your home, cooking and catering services for a party, and so forth.

The request date-time module 120 available through the application 105 allows the person shopping in the store to select a “request date-time” for each of the chosen items through execution of the item selection module 110. The “request date-time” is the date and time the person shopping wants the order to be providable by the store, wherein providable means ready for pick-up or delivery by someone. Similar to the discussion in the preceding paragraph, the application's 105 interface on the PSA 165 may present selectable, such as with a pen, drop-down menus, radio button, check boxes, and so forth for the date and time, i.e., “request date-time” the shopper wants each of the chosen items available for the store to provide for delivery or pick-up, and if delivery, then the person may specify the deliverer through the interface. The request date-time module's 120 interface, having further enabling logic, may optionally query the shopper to ask whether there are more items to choose, and, if so, permits an iteration of execution of both the item selection module 110 and request date-time module 120 until all the items that the shopper wants are ready for ordering. In an alternative embodiment, enabling logic, reduced to hardware and/or software, may permit a configuration of the application's 105 interfacing abilities on the PSA to not ask the shopper if there are more items to choose after each selection in order to avoid annoying the shopper, especially on having a large shopping list. In this alternative embodiment, the application's 105 request date-time module 120 may have logic enabling the checking of check-box or similar on the interface of the PSA's 165 screen to indicate that the order 185 is complete. It is noteworthy, however, that the application's 105 logic, further discussed below, includes yet another example embodiment whereby each of the selected items having particular request date-times may be an order 185, in itself, for a particular shopper, whereupon the application's 105 receiver module has logic working in tandem with the data collection center 175 to compile and aggregate each of the “individual” orders 185 according to request date-times.

Rather than discussing the series of individual streaming orders 185 referenced in the last sentence of the preceding paragraph, this disclosure, for ease of discussion, provides further example embodiments based on the example of an order 185 having all of the shopper's selected items by the PSA, whereupon the order 185 is wirelessly 195 sent by the application's 105 transmission module 130 to a receiver module 140 in communication with the store's data collection center 175. In this manner, the store obtains possession of the shopper's order 185 after the “selection date-time”, which is subsequent to the request date-time because the former happens earlier in time than the latter.

Moving forward, the application's 105 purchase module 170, also having enabling logic reduced to software and/or hardware like the entire system 100, permits a person shopping in the store to purchase the order 185 on the day of shopping or anytime through the actual receipt of the order 185 from the store. The purchase module 170 may present an interface on the PSA 165 for when, i.e., now or later, and by what means, i.e. credit or cash, the shopper wants to purchase the order 185. In the case of purchasing by credit, the purchase module 170 may enable the PSA 165 to accept scanning of a store's frequent shopper card, which may be tied to a shopper's or another person's purchasing card, e.g., debit, gift certificate, or credit. As an alternative, the shopper may scan a charging slot on PSA 165, itself, or manually enter the purchasing card's number and associated, relevant data on the interface of the PSA 165. In the case of purchasing by check or cash, the purchase module 170 may enable the shopper to pay a cashier at the store, wherein the cashier's register is in network communication, such as by network 195, with the application 105. In addition, the purchase module 170 may optionally permit the person, i.e., the shopper, to exactly when, but before the receipt date unless the store permits credit accounts for items without pay upfront, when the store may charge a purchase card for the order 185.

In still further enabling example embodiments, the purchase module 170 may permit, through an interactive interface, such as those previously described herein, on the PSA 165 to optionally hide the costs of the items on an optional receipt for the order 185 providable to someone picking-up or receiving a delivered order 185. Here, the purchase module 170, allows the person, i.e., shopper, the option of hiding the costs from someone, e.g., another person, picking-up or receiving the items in the order 185 on the request date-time, and, to that end, no receipt is also a possibility. Furthermore, the purchase module 170 may permit the shopper to send an electronic confirmation, with or without costs and either before or after purchase, to the person subsequent to the transmitting of the order. To effectuate that enabling ability, the purchase module 170 may present an interface on the PSA 165 for the person to enter an email address or fax number with a stylus or keyboard selection associated with the PSA 165. In the alternative, this interface may present an option to print the electronic confirmation of the order 185 on a printer local to the store. Before the order 185 is ultimately provided, the purchase module 170 verifies receipt of payment for the order 185. If not, payment may be made by someone at a cashier in the store or via paying through use of the PSA's 165 purchase module as above-discussed.

The application 105 provides still another two optional modules, namely a notification module 150 and a modification module 160. The application's 105 notification module 150 alerts the store that someone is in the store and ready to pick-up the order 185. The notification module 150 may provide an interface on a PSA 165, such as IBM's RSS, to inform the store that someone is present to pick-up the order 185 by entering a purchase order number, entering a credit card number if that was the means of pre-purchase, a store's frequent shopper card number, or by entering any other unique shopper identification number associated with the shopper. As an alternative, the notification module 150 may have an interface on the data collection center 175 that is accessible to someone picking-up the order 185. As yet another alternative, the notification module 150 may present a slideable slot or otherwise readable area associated with the data collection center 175, and optionally also the PSA 165, to inform the store that the order 185 should be filled within a very short period, if not already, and brought out for pick-up or delivery, wherein the latter is still “pick-up” for the deliverer.

The modification module 160 permits the person having shopped, or another authorized person, to modify the order 185. The modifying module 160 may present an interface, such as those previously discussed, that permit modifying, for example, the order form what was previously ordered in terms of identity and quantity of items, how the order was paid for by the shopper, changing the request date-time for one or more items, and any other changeable variables based on what was previously discussed by the modification module 160 working in tandem with the application's 105 other modules 110, 120, 130, 140, 150, 160, and 170.

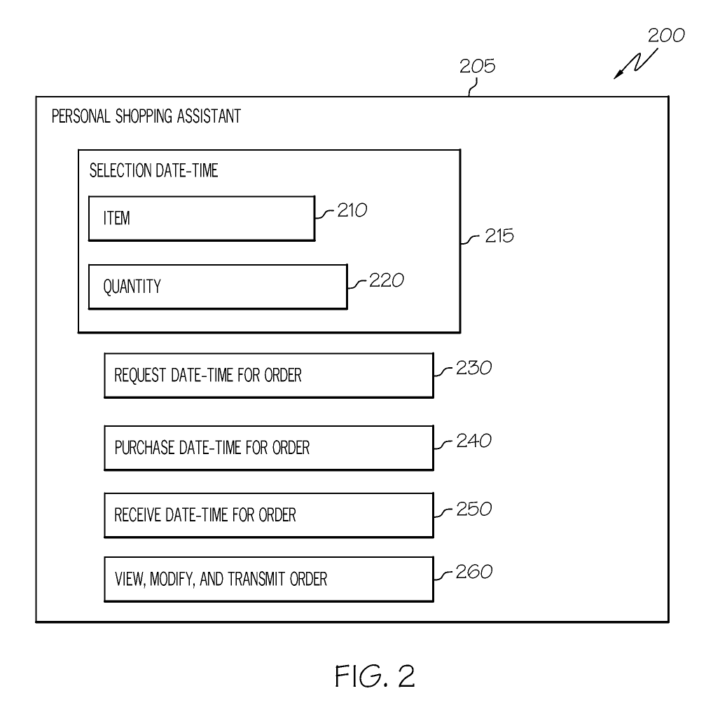

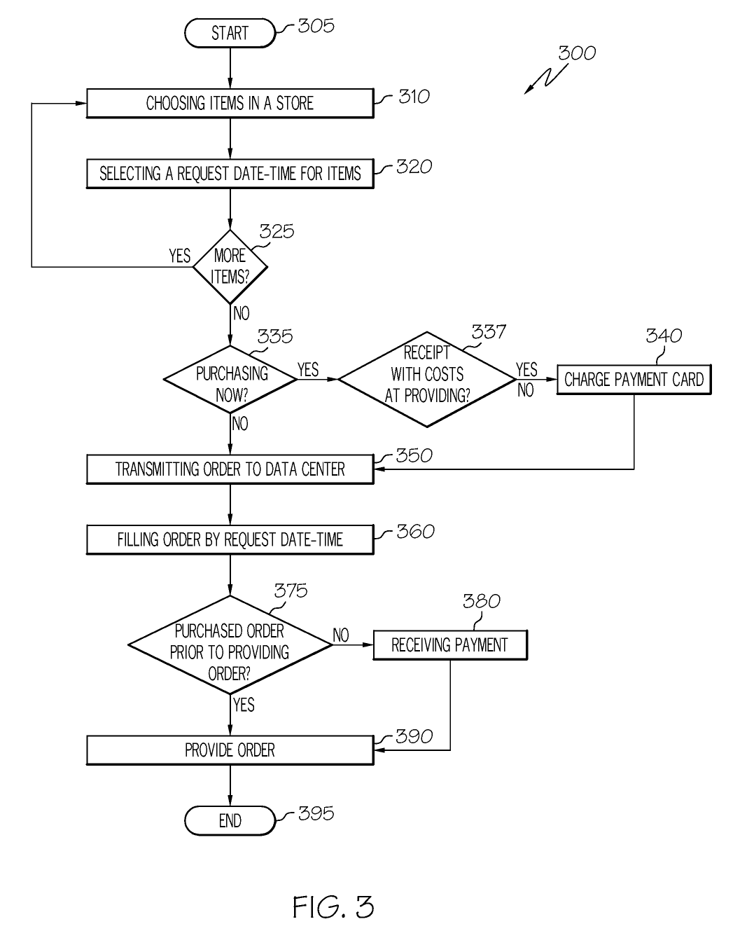

An aspect of the disclosure already discussed is disclosed in another manner in FIG. 2. In particular, an example embodiment of a block diagram of some interfaces relating to the aforementioned modules, namely 110, 120, 130, 140, 150, 160, and 170, in FIG. 1 are presented in FIG. 2. The block diagram interfaces are example interfaces that may appear on the PSA 205. An application on the PSA 205 may provide a selection date-time interface 215 to present specific menus, as discussed above, from which a shopper in a store could use to choose the quantity 220 of a particular item 210 the shopper wants to order. The request date-time for order interface 230 may allow the shopper to select a request date-time for each of the one or more items in the shopper's order. The purchase date-time for order interface 240 may allow a shopper to choose whether to pre-pay for the order, and how to pre-pay for the order, whether to send an electronic confirmation for the order, and, if so, with or without costs and to whom. The view, modify and transmit order interface may allow the shopper to view and confirm the order, change the placed order, and send the original or changed order to a data collection center working in concert with an application providing the logic for presenting such example interfaces and functionality on the PSA 205 to the shopper. Rather than further discussing this FIG. 2, reference is respectfully directed above and below for further example methods and/or systems in accordance with this disclosure, such as those already depicted by FIGS. 1 and 3.

Turning now to FIG. 3, another aspect of the disclosure is disclosed. In particular, an embodiment of a flowchart 300 of a method for ordering one or more items in a store is depicted. Flowchart 300 is for a system, such as system 100, as shown in FIG. 1. Enabling logic reduced to hardware and/or software within an application available on an associated with a PSA and a data collection center within a store permit the functionality discussed in the example embodiment depicted by FIG. 3.

Flowchart 300 starts 305 by a person, such as a shopper, choosing 310 one or more items in a store on a PSA via an interactive interface or a scanning device, e.g., pen, associated with the PSA that scans, for instance, a UPC of each item chosen. After choosing 310 an item, the application permits the person to select 320 a request date-time for each of the chosen 310 items. Then, the flowchart 300 shows an optional decision block 325 presented by the application through an interface, such as a graphical user interface, on the PSA. The decision block 325 queries the shopper as to whether there are more item(s) in the now chosen 310 and selected 320 item comprising the order at that point in time. If yes, the shopper answers yes on an interface of the PSA, then the shopping continues, i.e., choose 310 and select 320 an additional item, which is added to the order through the application's enabling logic, and the foregoing may iterate until the shopper says no, whereupon the order is closed. Another non-depicted embodiment allows each item chosen 310 and selected 320 by the shopper on the PSA to comprise an order for ultimately transmitting 350 to a data collection center subsequent to optional functionalities associated with pre-paying in this disclosure. Still, another, non-depicted embodiment of the application, i.e., possibility a different default configuration of the application on the PSA, allows the shopper to avoid being queried by decision block 325 subsequent to every choosing 310 and selecting 320 of an item so as not to annoy the shopper's otherwise shopping experience by incessant questions prompted by the application by a PSA interface.

Moving down the flowchart 300, the shopper is presented another decision block 335 that prompts the shopper through a PSA interface by asking if the shopper wants to purchase the order now. If yes, then a further decision block 337 similarly queries the shopper if there should be a receipt with costs or not available when the order is ready to be provided to the individual picking-up the order on or after the request date-time. As with other promptings through one or more interfaces on the PSA, the shopper may use a keyboard, or, a stylus or finger, for example, on the screen of the PSA, to indicate yes, no, choose an option in a menu provided, and so forth. Returning to the flowchart 300, if the user opts to purchase the order now 335, then the store may charge 340 a payment card associated with the shopper. If the user does not opt to pay at the time of the placing the order, then the order is transmitted 350 from the PSA to a data collection center associated with the store by means of a wireless connection. The order may be filled 360 instantly by the store, but before the request date-time associated with the order. In a non-depicted, but previously discussed embodiment, the order may be filled when someone associated with the shopper, which includes the shopper as well, notifies the store of their presence in the store and that the order should be filled, if not already, in a very limited amount of time. Moving towards culmination of the example method, flowchart 300 presents another decision block 375 that allows the application to query the store as to whether the filled 360 order has been purchased. If no, then the store may receive 380 payment for the order prior to providing 390 the order. The individual receiving the order for pick-up or delivery may pay for the order at pick-up using the PSA or a cashier as previously discussed. Equally, the individual may modify the order as previously discussed herein. In the alternative, if the query 375 as to whether filled 360 order has been purchased is yes, then the order may be provided to the individual picking-up the order. The flowchart then ends 395.

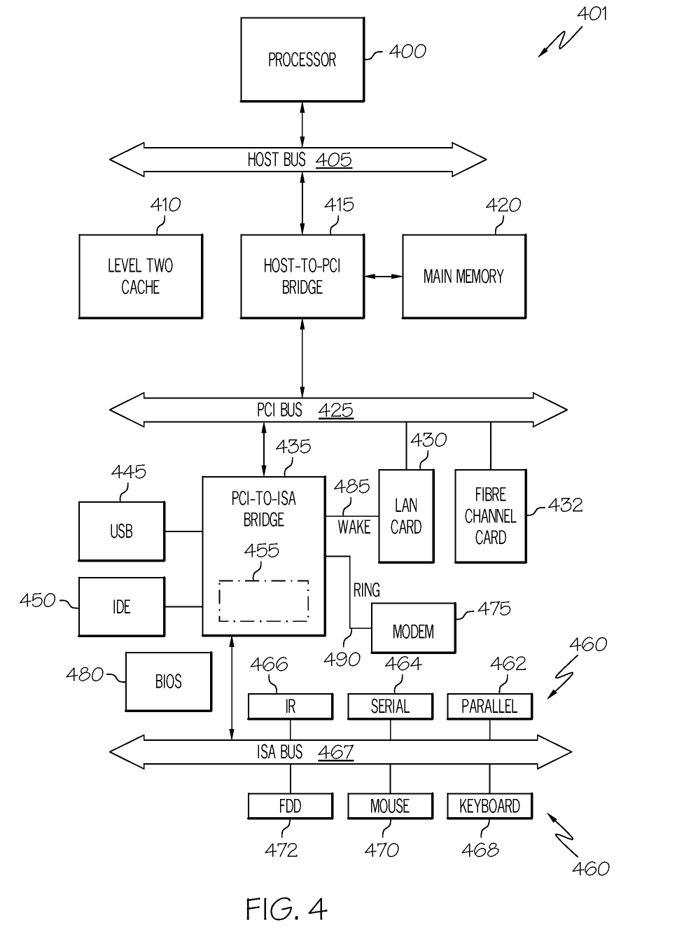

FIG. 4 illustrates information handling system 401 which is a simplified example of a computer system, such as computerized personal shopping assistant 105 in FIG. 1 working in wireless network communication 195 with the data collection center 175 also shown in FIG. 1 for ordering one or more items in a store, and capable of performing the operations described herein. Computer system 401 includes processor 400 which is coupled to host bus 405. A level two (L2) cache memory 410 is also coupled to the host bus 405. Host-to-PCI bridge 415 is coupled to main memory 420, includes cache memory and main memory control functions, and provides bus control to handle transfers among PCI bus 425, processor 400, L2 cache 410, main memory 420, and host bus 405. PCI bus 425 provides an interface for a variety of devices including, for example, LAN card 430. PCI-to-ISA bridge 435 provides bus control to handle transfers between PCI bus 425 and ISA bus 467, universal serial bus (USB) functionality 445, IDE device functionality 450, power management functionality 455, and can include other functional elements not shown, such as a real-time clock (RTC), DMA control, interrupt support, and system management bus support. Peripheral devices and input/output (I/O) devices can be attached to various interfaces 460 (e.g., parallel interface 462, serial interface 464, infrared (IR) interface 466, keyboard interface 468, mouse interface 470, fixed disk (HDD) 472, removable storage device 474) coupled to ISA bus 467. Alternatively, many I/O devices can be accommodated by a super I/O controller (not shown) attached to ISA bus 467.

BIOS 480 is coupled to ISA bus 467, and incorporates the necessary processor executable code for a variety of low-level system functions and system boot functions. BIOS 480 can be stored in any computer-readable storage medium, including magnetic storage media, optical storage media, flash memory, random access memory, read only memory, and so forth. In order to attach computer system 401 to another computer system to copy files over a network, LAN card 430 is coupled to PCI bus 425 and to PCI-to-ISA bridge 435. Similarly, to connect computer system 401 to an ISP to connect to the Internet using a telephone line connection, modem 475 is connected to serial port 464 and PCI-to-ISA Bridge 435.

While the computer system described in FIG. 4 is capable of executing the disclosure described herein, this computer system is simply one example of a computer system. Those skilled in the art will appreciate that many other computer system designs are capable of performing the disclosure described herein.

Another embodiment of the disclosure is implemented as a program product for use within a device such as, for example, those systems and methods depicted in FIGS. 1-3. The program(s) of the program product defines functions of the embodiments (including the methods described herein) and can be contained on a variety of data-bearing media. Illustrative data-bearing media include, but are not limited to: (i) information permanently stored on non-writable storage-type accessible media (e.g., read-only memory devices within a computer such as CD-ROM disks readable by a CD-ROM drive); (ii) alterable information stored on writable storage-type accessible media (e.g., floppy disks within a diskette drive or hard-disk drive); and (iii) information conveyed to a computer by a communications medium, such as through a computer or telephone network, including wireless communications. The latter embodiment specifically includes information downloaded onto either permanent or even sheer momentary storage-type accessible media from the World Wide Web, an internet, and/or other networks, such as those known, discussed and/or explicitly referred to herein. Such data-bearing media, when carrying computer-readable instructions that direct the functions of the present disclosure, represent embodiments of the present disclosure.

In general, the routines executed to implement the embodiments of this disclosure, may be part of an operating system or a specific application, component, program, module, object, or sequence of instructions. The computer program of the present disclosure typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of this disclosure. However, it should be appreciated that any particular program nomenclature that follows is used merely for convenience, and thus this disclosure should not be limited to use solely in any specific application identified and/or implied by such nomenclature.

While the foregoing is directed to example embodiments of this disclosure, other and further embodiments of this disclosure may be devised without departing from the basic scope thereof, and the scope thereof is determined by the claims that follow.

1. A method for ordering one or more items, the method comprising:
choosing, by a person in a store, the one or more items on a computerized personal shopping assistant;
selecting, by the person in the store, a request date-time on the computerized personal shopping assistant for each of the one or more items chosen, and, thereby, resulting in an order of one or more selected items at a selection date-time, wherein the request date-time is subsequent to the selection date-time and the request date-time for at least one of the one or more selected items is on a subsequent visit to the store as compared to a date-time of the person in the store;
transmitting, by the computerized personal shopping assistant, the order to a data collection center associated with the store;
filling, by the store, the order after the transmitting;
purchasing the order; and
providing, by the store, the order by the request date-time.

2. The method of claim 1, wherein the choosing comprises choosing the one or more items selected from a group consisting of currently available items in the store and currently unavailable items in the store but available by the request date-time.

3. The method of claim 1, wherein the purchasing comprises purchasing the one or more items selected from a group consisting of at the selection date-time for the order and at a providing date-time for the order.

4. The method of claim 1, wherein the purchasing comprises showing a cost for each of the one or more items in the order to the person but not to the another person provided the order by the providing.

5. The method of claim 1, wherein the providing comprises providing selected from a group consisting of delivery by the store of the order, picking-up of the order by the person, and picking-up of the order by another person associated with the person.

6. The method of claim 1, further comprising modifying the order in the store subsequent to the purchasing and prior to the receiving.

7. The method of claim 1, further comprising alerting the store for the filling of the order by a reading of a unique shopper identification number associated with the person having selected the order.

8. The method of claim 1, further comprising sending an electronic confirmation to the person subsequent to the transmitting of the order.

9. A system for ordering of one or more items, the system comprising:
an application associated with a computerized personal shopping assistant having a processor, wherein the computerized personal shopping assistant is optionally associated with a cart;
an item selection module within the application available through the computerized personal shopping assistant, for choosing, by a person in a store, on the computerized personal shopping assistant, the one or more items;
a request-date time module within the application available through the computerized personal shopping assistant, for selecting, by the person in the store, a request date-time on the computerized personal shopping assistant for each of the one or more items chosen, and, thereby, resulting in an order of one or more selected items at a selection date-time, wherein the request date-time is subsequent to the selection date-time and the request date-time for at least one of the one or more selected items is on a subsequent visit to the store as compared to a date-time of the person in the store;
a transmission module within the application available through the computerized personal shopping assistant, for transmitting, by the computerized personal shopping assistant, the order to a data collection center associated with the store;
filling, by the store, the order after execution of the transmission module and receipt of the order by a receiver module; and
providing, by the store, the order by the request date-time subsequent to a purchase of the order.

10. The system of claim 9, wherein the one or more items are a type selected from the group consisting of perishable goods, non-perishable goods, and services.

11. The system of claim 9, wherein each of the one or more items comprise a uniform product code.

12. The system of claim 9, wherein the transmission module comprises a wireless communication of the order from the computerized personal shopping assistant to a receiver module available through the application and associated with the data collection center.

13. The system of claim 9, further comprising a purchasing module within the application available through the computerized personal shopping assistant for purchasing the one or more items selected from a group consisting of at the selection date-time for the order and at a providing date-time for the order.

14. The system of claim 9, further comprising a modification module within the application available through the computerized personal shopping assistant for modifying the order in the store subsequent the purchasing and prior to the receiving.

15. The system of claim 9, further comprising a notification module for alerting the store for readying the order by a reading of a unique shopper identification number associated with the person having selected the order.

16. A machine-accessible storage medium containing instructions, which when executed by a machine, cause the machine to perform operations for ordering one or more items, comprising:
choosing, by a person in a store, the one or more items on a computerized personal shopping assistant;
selecting, by the person in the store, a request date-time on the computerized personal shopping assistant for each of the one or more items chosen, and, thereby, resulting in an order of one or more selected items at a selection date-times, wherein the request date-time is subsequent to the selection date-time and the request date-time for at least one of the one or more selected items is on a subsequent visit to the store as compared to a date-time of the person in the store;
transmitting, by the computerized personal shopping assistant, the order to a data collection center associated with the store;
filling, by the store, the order after the transmitting;
purchasing the order; and
providing, by the store, the order by the request date-time.

17. The machine-accessible storage medium of claim 16, wherein the instructions for choosing the one or more items selected from a group consisting of currently available items in the store and currently unavailable items in the store but available by the request date-time.

18. The machine-accessible storage medium of claim 16, wherein the instructions for providing comprises providing selected from a group consisting of delivery of the order, picking-up of the order by the person, and picking-up of the order by another person associated with the person.

19. The machine-accessible storage medium of claim 16, further comprising instructions for modifying the order in the store subsequent to performing the instructions for purchasing and prior to performing the instructions for receiving.

20. The machine-accessible storage medium of claim 16, further comprising instructions for alerting the store for filling of the order by performing instructions for reading of an identification associated with the person having selected the order.
